(19) United States
(12) Patent Application Publication
(10) Pub. No.: US 2006/0287920 A1
(43) Pub. Date: Dec. 21, 2006

(54) Method and system for contextual advertisement delivery

(76) Inventors: Carl Perkins, Santa Ana, CA (US); Duane Brinson, Santa Ana, CA (US); Philip Dizon, Irvine, CA (US); Jesse Pelayo, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 11/445,680

(22) Filed: Jun. 1, 2006

Related U.S. Application Data
(60) Provisional application No. 60/686,206, filed on Jun. 1, 2005.

(51) Int. Cl. G06Q 30/00; G06F 17/00

(52) U.S. Cl. 705/14; 707/104.1

(57) ABSTRACT

A method and system for providing contextual advertising content from an advertising database is disclosed. Content data of a target server may be scanned for a matching keyword, which may be provided by a weighted keyword database. A subset of the content data may be generated, in which the subset may be the matching keyword. A weight may be assigned to the matching keyword, based upon a comparison to the weighted keyword database. An advertising content request may be generated based upon the assigned weight of the matching keyword.

### CROSS-REFERENCE TO RELATED APPLICATIONS

This application relates to and claims the benefit of U.S. Provisional Application No. 60/686,206 filed Jun. 1, 2005 and entitled CONTEXTUAL ADVERTISEMENT SERVER AND WEB PAGE TAG METHODOLOGY, which is incorporated by reference herein.

### STATEMENT RE: FEDERALLY SPONSORED RESEARCH/DEVELOPMENT

Not Applicable

### BACKGROUND OF THE INVENTION

1. Technical Field

The present invention generally relates to methods and systems for delivering advertising. More particularly, the present invention relates to methods and systems for delivering contextual advertisements on a webpage based on content located within the webpage.

2. Related Art

Since its inception, the Internet, and specifically, the World Wide Web (WWW), has been utilized as an engine of commerce. Earlier commercial activity typically consisted of providing information relating to a good sold by a retailer. The WWW added a level of interactivity that was not possible through conventional catalog and phone ordering systems. Product information, including graphics associated with a particular product, made evaluation considerably easier. Because the information was available at all hours of the day, the need for a sales force decreased. Eventually, retailers made the goods available for sale through the Internet, where a user could access a webpage of the retailer to place orders and make payments for a particular item. With improved shipment services, locally produced goods could be sent anywhere in the country, or anywhere in the world.

Simultaneously, newspapers and other like content providers established a presence on the WWW. Nationally known news organizations began publishing newspaper content on the WWW, followed by local newspapers. Additionally, in part due to the open nature of the Internet, individuals with Internet connections started to publish all matters of interest on the WWW. While such personal websites typically defy strict categorization, the more frequently updated sites are commonly known as web logs, or “blogs.”

With the burgeoning costs associated with maintaining a website, including server maintenance, domain name registration, extra bandwidth costs, and so forth, providing the information for free was less desirable than having a means of compensation to offset costs. Accordingly, publishers experimented with a variety of compensation models, such as advertising, receiving from a user a small payment, typically in the range of a few cents to a dollar or more, for access to restricted content, and the like. Advertising is a commonly utilized source of revenue for websites, and for some websites, has become the sole source of revenue. Conventionally, “banner ads,” which are designed according to the advertiser's choosing and linked back to the advertiser's website, are placed in a prominent position on the content provider's webpage.

Initially, the compensation was based on the number of times that the “banner ad” was displayed on a website, similar to the billing model for print media. This model is known as CPM or Cost-Per-Thousand displays. For a premium fee, advertisers could select individual websites that provided a strong correlation with the desired demographic target audience, i.e. placing an ad for sports memorabilia on a single sports oriented website. For a slightly lower fee, the advertiser could specify the display of ads on a group of websites that attracted a similar demographic target audience, i.e. placing an ad for sports memorabilia on a group of sports oriented websites. For the lowest rate, advertisers could have their ads displayed across all of the websites within a particular advertiser aggregation network. Correspondingly, each plan provided a decreasing click-through rate on the ad banner. This led to a more sophisticated charging model where the advertiser only paid when a user clicked on the ad banner and was redirected to the advertiser's website. This is known as PPC or Pay-per-Click advertising.

With random cycling of banner ads, it was recognized that there was a high likelihood of a given ad being received by a non-responsive user. In order to improve the response rates to the banner ads, it was soon recognized that the advertisements targeted to the particular user's interest were more effective. One method was to provide a search query input on the website, to which a user could simultaneously search for content and be presented with advertisements as relevant to that search query. However, this was deficient in that most web pages do not offer search capabilities, and that the only entities generating significant advertising revenue according to this methodology were search engines.

Websites with fairly consistent content, such as ESPN, MERRIL-LYNCH, and the like, could simply run ads based upon their stable demographic profile. Large commercial websites, such as MSN, CNET, and CNN were able to afford editors to manually review web pages and to select appropriate ad content. However, these solutions were impractical for many content providers, particularly smaller news concerns and personal publishers. In response, a number of automated ad placement techniques were developed that would allow for ads to be placed on websites having the highest probability of generating a response, or click from the user.

One such development was the linguistic analysis of the contents of a given web page. This approach utilized complex rules based upon the particular language of the content to determine the meaning of the content. Such techniques were deficient due to its limited application to only a single language and extensive development efforts necessary in order to develop new rule sets for other languages. Additionally, the linguistic analysis techniques do not readily support the rapid adoption and abandonment of terms used in the popular vernacular, i.e. “blog”, “That's Hot” (as used by Paris Hilton, not in reference to the temperature of an object), Abu Gharib, Sidekick (the popular cell phone/web terminal), and so forth. Therefore, there is a need in the art for an improved contextual advertisement delivery system and method.

### BRIEF SUMMARY

In accordance with one aspect of the present invention, there is disclosed a method for providing advertising content from an advertising database. The method may include the step of scanning content data of a target server for a matching keyword from a weighted keyword database. The method may also include the step of generating a subset of the content data. The subset may be the matching keyword. Further in accordance with an aspect of the present invention, the method may include the step of assigning a weight to the matching keyword. The assigning may be based upon a comparison to the weighted keyword database. The method may also include the step of generating an advertising content request in accordance with the assigned weight. The advertising content request may be operative to initiate the transmission of advertising content from the advertising database.

According to another aspect of the present invention, there is provided an article of manufacture which may include a computer usable medium having computer-readable code. The code may be provided for scanning content data of a target server for a matching keyword from a weighted keyword database. The code may also be provided for generating a subset of the content data, where the subset is the matching keyword. Additionally, the code may be provided for assigning a weight to the matching keyword based upon a comparison to the weighted keyword database, as well as for generating an advertising content request. The advertising content request may be in accordance with the assigned weight, and may be operative to retrieve advertising content from an advertising database.

In accordance with still another aspect of the present invention, there is disclosed a system for providing advertising content. The system may include at least one memory for storing a weighted keyword database. Further, there may be a processor for scanning content data of a target server for a matching keyword from the weighted keyword database. Additionally, the processor may be provided for generating a subset of the content data, the subset being the matching keyword. Still further, the processor may be provided for storing the subset on the at least one memory. The processor may also be included for assigning a weight to the matching keyword based on a comparison to the weighted keyword database. Moreover, the processor may be included in the system for generating an advertising content request in accordance with the assigned weight. The processor may also be provided for transmitting the advertising content request and for retrieving the advertising content from an advertising database.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of an exemplary system in which the present invention may be implemented;

FIG. 2 is a combined block diagram/flowchart illustrative of one aspect of the present invention;

FIG. 3 is a diagram of an exemplary client-side advertisement tag operative to activate the retrieval of an advertisement;

FIG. 4 is a flowchart illustrating the steps performed in accordance with the present invention;

FIG. 5 is an exemplary browser output illustrating an HTML output page juxtaposed to an advertisement feed generated in accordance with an aspect of the present invention.

FIGS. 6a-b are flowcharts illustrating the steps performed by an analysis server in cooperation with a page-keyword cache;

FIG. 7 is a flowchart illustrating the steps performed by the analysis server without the page-keyword cache;

FIG. 8 is a flowchart illustrating the steps performed specifically by a page analyzer in accordance with one aspect of the present invention;

FIG. 9 is a flowchart illustrating the loading of a weighted keyword database into memory;

FIGS. 10a-c are memory block diagrams of the weighted keyword database, a corresponding word index, and a corresponding letter index;

FIG. 11 is a flowchart detailing the process of analyzing a page in accordance with an aspect of the present invention, including the stripping, comparing, and outputting steps;

FIGS. 12a-c are flowcharts illustrating the detailed steps involved with stripping the HTML output page content of HTML tags to yield a stripped page content;

FIGS. 13a-c are flowcharts illustrating the detailed steps pertaining to the comparison of the stripped page content to the weighted keyword database; and

FIGS. 14a-e are memory block diagrams of a buffer, the weighted keyword database, a corresponding word index, and a corresponding letter index.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second, and the like are used solely to distinguish one from another entity without necessarily requiring or implying any actual such relationship or order between such entities.

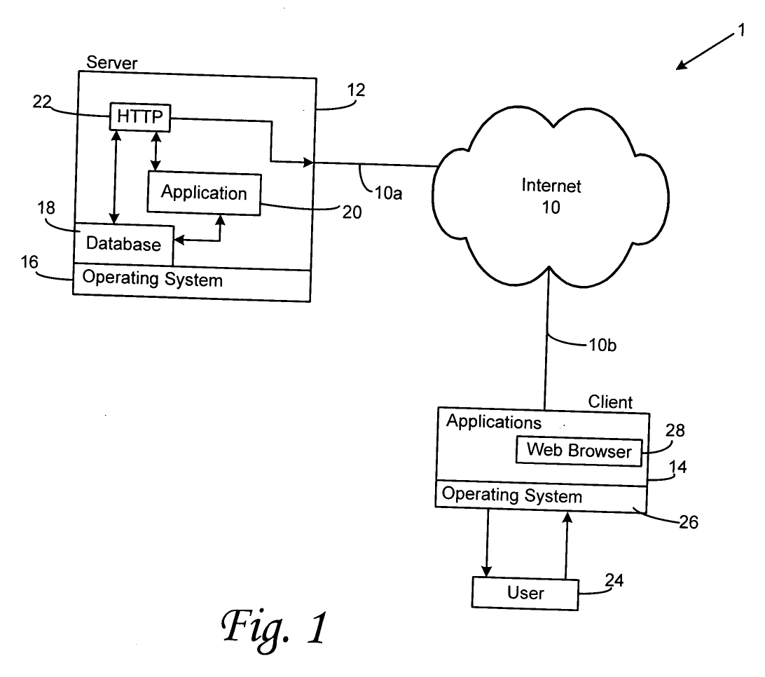

With reference now to FIG. 1, an exemplary system 1 for implementing the present invention is illustrated. Connected to an Internet 10 via Internet link 10a is a server 12, and connected to the Internet 10 via Internet link 10b is a client 14. As will be understood by those of ordinary skill in the art, the Internet 10 refers to a network of networks that may use a variety of well known protocols for data exchange, such as TCP/IP, ATM and so forth. The server 12 is a conventional data processing system being operative to receive data processing requests and to respond to such requests. Accordingly, there is included a processor, volatile memory, non-volatile memory, and a network communications device for transmitting specified data to the Internet 10, any clients 14, or other like data processing systems connected thereto.

The server 12 includes a server operating system 16, which manages certain hardware components such as the aforementioned processor, volatile and non-volatile memory, and the like, as well as additional software. Such software may include a database 18, a server application 20, and an HTTP server 22. Among the common server operating systems 16 include UNIX, variations thereof such as AIX, FREEBSD, and LINUX, as well as MICROSOFT WINDOWS. The server operating system 16 and other software 18, 20, and 22 are tangibly embodied in a computer-readable medium, e.g. one or more of the volatile or nonvolatile memories. The server operating system 16 and the additional software 18, 20, and 22 may be loaded from an external data storage device into memory for execution by the processor, and comprise instructions which, when read and executed by the processor, cause the server 12 to perform the steps necessary to execute the steps or features of the present invention. In this regard, it will be appreciated by those having ordinary skill in the art that server application 20 may include instructions for retrieving data from the database 18, formatting the retrieved data according to a predetermined arrangement to yield a resultant output, and transmitting the output to the HTTP server 22 for transmission to a client 14 through the Internet 10. The HTTP server may be of any desired variety, include APACHE, MICROSOFT INTERNET INFORMATION SERVER (IIS) and so forth. It will also be appreciated that the data retrieval instructions may be initiated by communications received from the client 14 or from other sources.

The client 14 is also a conventional data processing system, but may also include additional input and output devices such as a monitor, a printer, a keyboard, or a mouse, which a user 24 may utilize in operating the client 14. As was described above in relation to the server 12, the client 14 may likewise include a processor, a volatile memory, a non-volatile memory, and a network communication device. A client operating system 26 also manages the various hardware components of the client 14 and any additional software running thereon. It will be appreciated that while the client operating system 26 is commonly MICROSOFT WINDOWS or APPLE MACOS, any desirable client operating system 26 may be utilized. With respect to the additional software running on the client 14, by way of example only and not of limitation, there is a web browser 28. The web browser 28 may be INTERNET EXPLORER, MOZILLA FIREFOX, APPLE SAFARI, etc. As will be readily understood by one of ordinary skill in the art, the user 24 may specify a particular resource to access on the Internet 10, for example, server 12, and retrieve particular data stored thereon by specifying a query through the web browser 28. It is further understood that in one query, the client 14 may be in communication with more than one server 12, resulting in data from multiple sources being rendered on the web browser 28.

It will be appreciated that the system 1 and the details thereof are presented by way of example only and not of limitation, and that the system 1, including the server 12 and the client 14, may be varied in numerous ways without departing from the present invention. Thus, the terms “client,” “server,” and “browser” have the import of commonly and well known meanings associated therewith as understood by one of ordinary skill in the art. Such a person will be able to readily ascertain variations of the system 1 and its components, and all such variations are deemed to be within the scope of the invention as presently contemplated. Having discussed the exemplary system 1 in which the present invention may be embodied, a broad overview of the present invention will now be considered.

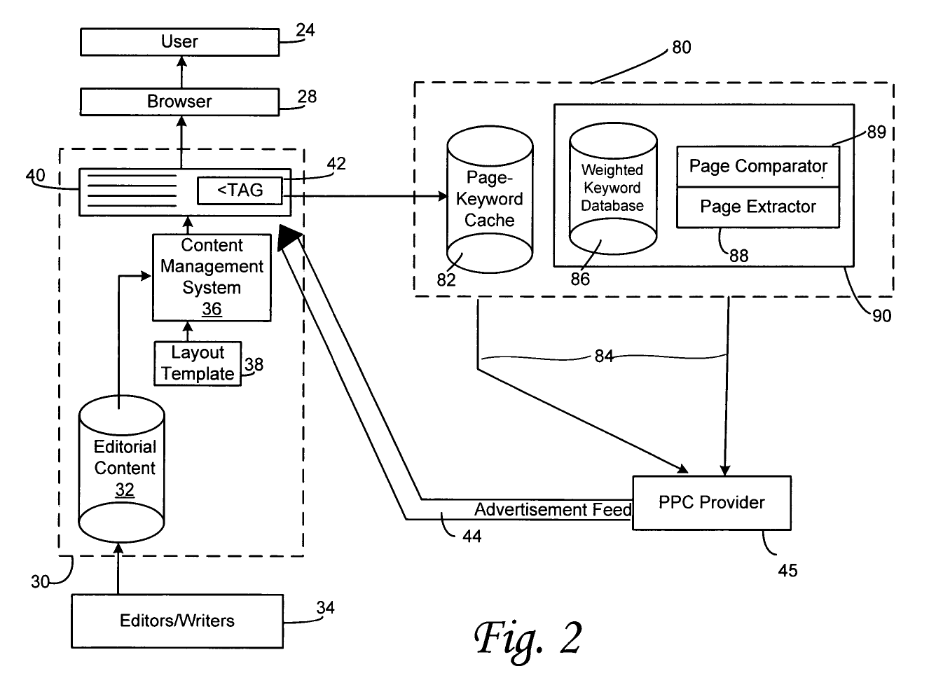

With reference to FIG. 2, there is illustrated generally the various components of the present invention. Content provider server 30, which is also referred to herein as a target server, includes an editorial content database 32. The editorial content database 32 may include various news articles, editorials, and other informational data drafted and uploaded thereto by editors/reporters 34. Such data is retrieved by a content management system 36, and is formatted according to one or more layout templates 38 to give the HTML output 40 transmitted to the user 24 a desired aesthetic appearance upon being rendered by the web browser 28. In this regard, the layout template 38 may conform to the Cascading Style Sheets (CSS) presentation specification language. It will be appreciated that while specific mention is made of the content provider server 30 being associated with a news organization, it is so mentioned by way of example only and not of limitation, and any other content provider may be readily substituted without departing from the scope of the present invention. As will be apparent to one of ordinary skill in the art, with reference to FIGS. 1 and 2, the content database 32 roughly correlates to the database 18, and the content management system 36 correlates to the server application 20. The content management system 36 performs specific data manipulation functions for retrieving and formatting data according to a set of received inputs, and returning the results of such manipulation functions. It is to be understood that each query to the content management system 36 for data will generate an individual HTML output page 40.

Either upon parsing the HTML output page 40 or after the HTML output page 40 is transmitted to the browser 28, a specific advertising identifier 42 recognized either by the content management system 36 or the browser 28 is parsed to initiate the retrieval of an advertising feed 44. The advertising identifier 42 may be in the form of a server-side command parsed by the content management system 36 or, in accordance with the preferred embodiment, may be a client-side JAVASCRIPT code embedded within the HTML output 40. In either case, the advertising identifier 42 is operative to activate the retrieval of the advertisement feed 44.

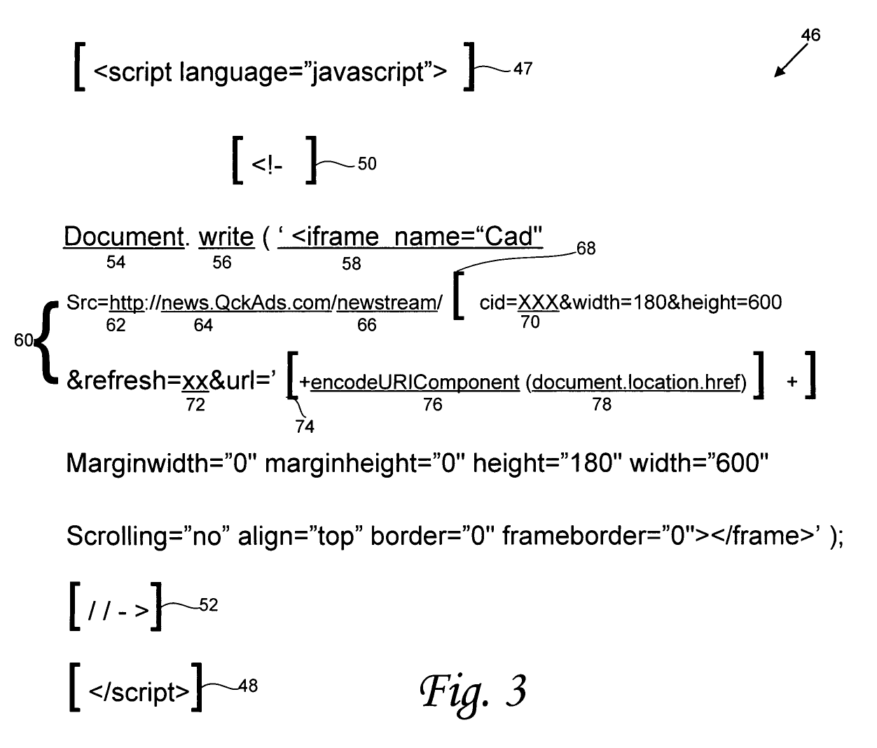

With reference to FIG. 3, the JAVASCRIPT code snippet 44 begins with an HTML compliant script activation segment 47 which instructs an HTML rendering engine on the browser 28 to activate a JAVASCRIPT interpreter to parse the subsequent text until a script deactivation segment 48 is reached. It will be appreciated by one of ordinary skill in the art that an HTML begin comment tag 50 hides the JAVASCRIPT code segment from the HTML rendering engine until an HTML end comment tag 52 is reached. The interface identifier 54 specifies the “Document” interface of the Document Object Model, and specifies a function identifier 56, which invokes the “write” function. Within the parenthesis are enclosed parameters to the write function, which is specified by the function identifier 56. The write function is instructed to generate an inline frame having a particular name 58 and a source 60.

The source 60 is structured as a Uniform Resource Identifier (URI) including a scheme 62 that indicates the protocol used to retrieve a representation of the resource, set forth as the Hyper Text Transfer Protocol, or HTTP. Further, the source 60 includes an authority 64 that identifies a server. Optionally, depending on the configuration of the server, may include a path 66. This is followed by a query 68 which is comprised of a customer identifier 70, a refresh rate parameter 72, and a location identifier 74, among others. The location identifier 74 specifies the URI of the present HTML output page 40, that is, the location of the page invoking the presently running instance of the code snippet 46. A function 76 “encodeURIComponent” is called with a URI parameter 78 “document.location.href.” The function 76 is operative to encode the URI value stored in the parameter 68, as a string of text for use as the location identifier 74. Generally, it will be appreciated that the query 68 designates parameters of a dynamic query to a database, application, or the like residing and running on the server identified by the path 66. The operational details of the present invention with respect to the aforementioned URI parameters will be explained in further detail below. Other parameters to the “write” function include margin width, size of the advertisement feed 44, color scheme, font styles, and so forth, and one of ordinary skill in the art will appreciate the results of including these parameters without further explanation.

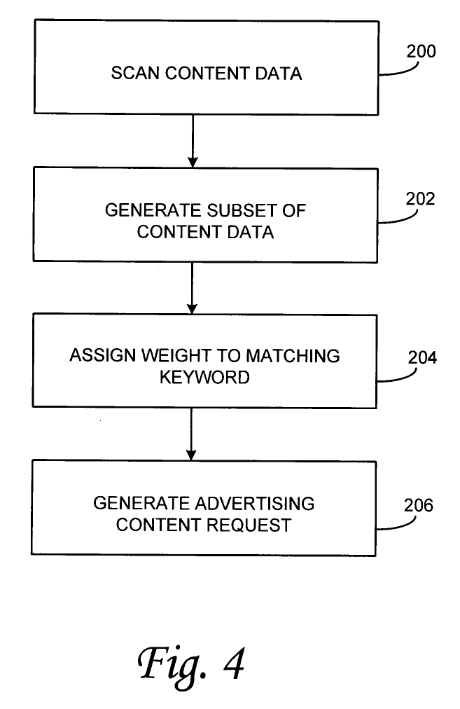

Referring to FIGS. 2 and 3, it is contemplated that the server identified by the authority 64 is an analysis server 80. As further shown in FIG. 4, and per step 200, content data on a target server is scanned and compared to entries of a weighted keyword database 86. As explained above, the target server is equivalent to the content provider server 30, and the content data is equivalent to the HTML output page 40. Having passed the location identifier 74 of the HTML output page 40 as the query 68, specifically as the location identifier 74, the analysis server 80 retrieves the content contained within the HTML output page 40.

As set forth in step 202, a subset of the HTML output page 40, i.e., the content data, is generated. The content data is matched with entries of the weighted keyword database 86 to yield one or more matching keywords.

According to a first embodiment, before retrieving the HTML output page 40, a page-keyword cache 82 may be consulted to determine whether the page specified by the location identifier 74 exists in the page-keyword cache 82. If a record exists for the particular page as specified by the location identifier 74, the HTML output page 40 has already been analyzed and so an advertising content request 84 is issued to an advertisement database 45, as per step 206. In order to remain updated, the page-keyword cache 82 may be refreshed from time to time as specified by the refresh rate parameter 72. Refresh time is typically set to the expected length of time the page will remain static, and this aids in reducing load on the content provider server 30 and the advertisement database 45. It is understood that most web pages remain static over short periods of time, for example, a few hours. Another exemplary method in which the page-keyword cache 82 may be refreshed is by way of a spidering process. Such a process would typically be utilized where large collections of data are being simultaneously updated, for example, when a news website is updated with a new edition.

The advertising identifier 42 is generally specific to each unique one of the HTML output page 40, and so different values for the refresh rate parameter 72 may be specified. It is expressly contemplated, however, that the advertising identifier 42 may be generic to all pages of a website. As is apparent from the existence of the customer identifier 70, the analysis server 80 is capable of handling multiple content provider servers 30 having separate ownership. Accordingly, the analysis server 80 may have multiple instances of the weighted keyword database 86 and the page-keyword cache 82 for each content provider server 30. The customer identifier 70 is therefore used to distinguish one server 30 from the other when determining which weighted keyword database 86 and page-keyword cache 82 to utilize.

If a record does not exist for the page specified by the location identifier 74, according to one embodiment of the present invention, the advertisement database 45 may be instructed to transmit a generic “category advertisement.” Thus, when a new page is added and the advertising identifier 42 is invoked for the first time, the same procedure is followed. Another instance where such a generic “category advertisement” may be invoked is where the word content of the HTML output page 40 is inadequate to accurately determine its context. Although this default process is not the ideal way to deliver advertisements to the user 24, some degree of control may be maintained, however by specifying particular categories of desired advertisements via a “category” parameter incorporated into the query 68. It is noted that while this would require some degree of knowledge as to the contents of the HTML output page 40, but a sufficiently broad category may be set forth which may nevertheless be relevant to the targeted user 24.

After instructing the advertisement database 45 to transmit a generic category advertisement, the HTML output page 40 associated with the value of the location identifier 74 is retrieved by a page content extractor 88, and compared to the weighted keyword database 86 with a page comparator 89. Collectively, the page content extractor 88 and the page comparator 89 are referred to as the page analyzer 90. It is to be understood that when a new web page is added and the advertising identifier 42 parsed for the first time, the same process as described occurs. Generally, per step 204, a weight is assigned to the matching keyword, which is based upon a comparison to the weighted keyword database 86. After the analysis, per step 206, the advertising content request 84 may be transmitted to the advertisement database 45. This will instruct the browser 28 to load relevant advertisements at the position within the HTML output file 40 that corresponds to the location of the advertising identifier 42 were it to be rendered as a visible element. The result of the analysis may also be stored back into the page-keyword cache 82.

In an alternative embodiment, the page-keyword cache 82 may be eliminated, along with any cache expiration determinations associated therewith. Thus, in such an alternative embodiment, each HTML output page 40, when requested by the user 24, may be analyzed by the page analyzer 88 prior to transmitting the advertising content request 84.

With respect to the advertisement database 45, one of ordinary skill in the art will recognize that it is a conventional “pay per click” provider which generates the advertisement feed 44 given a particular advertising content request 84. The advertisement feed 44 is described utilizing the eXtensible Markup Language (XML) and composed according to well recognized formats for the dynamic placement of advertisements on web pages. As will be appreciated, the use of standard formats permit the content provider server 30 to access multiple sources for advertisements, and need not be limited to a single provider. For example, if one advertisement server were to go offline, another one may be readily substituted without interruption. Additionally, multiple sources/advertisement databases 45 may be combined in the advertisement feed 44.

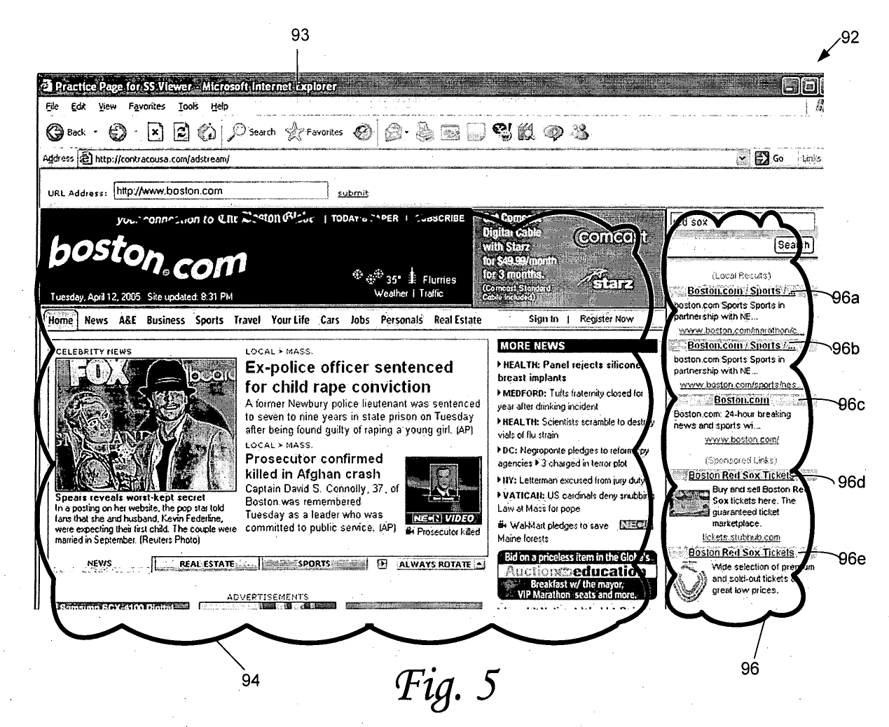

Referring now to FIGS. 2 and 5, a screenshot of an exemplary output from the web browser 28 is depicted. In the screenshot 92, there is a browser window 93, which is generally divided into a content section 94 disposed on the left hand side of the browser window 94, and an advertising section 96 disposed on the right hand side of the browser window 94. Given the above description of the present invention, it will be understood that the content section 94 is rendered from the HTML output page 40, and the advertising section 96 is rendered from the advertisement feed 44. The words and phrases in the content section 94 are analyzed, and the advertisements in the advertisement section 96 are contextually related to such words and phrases. For example, analyzed to be a matching keyword is the term “Boston.” Accordingly, the advertisement section 96 includes numerous advertisements 96a-96e which are relevant to Boston, such as advertisement 96a for Boston Red Sox tickets.

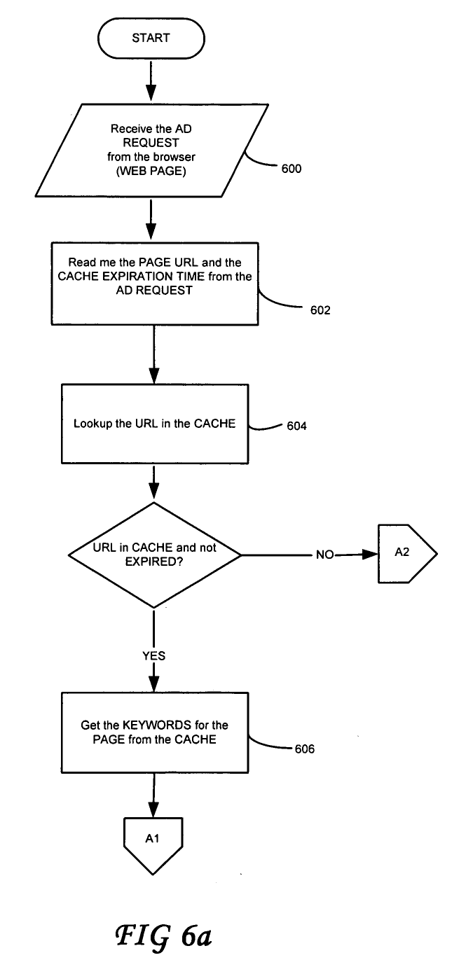

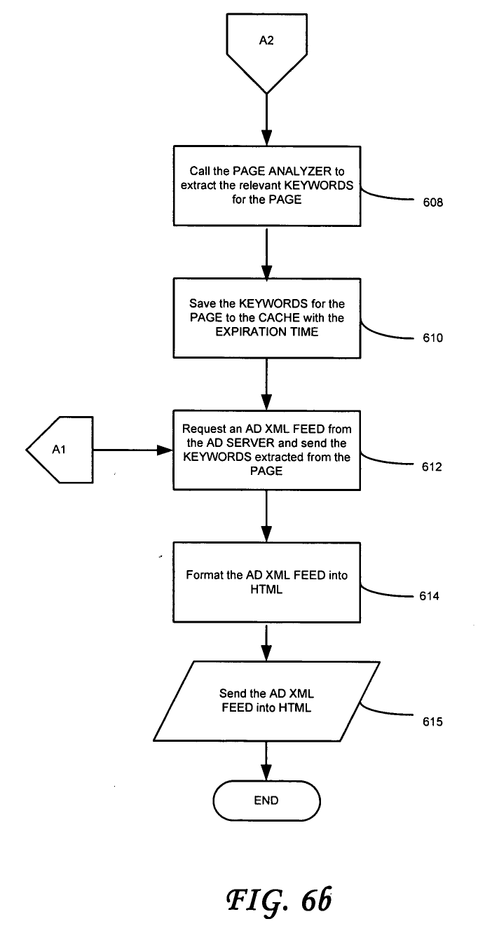

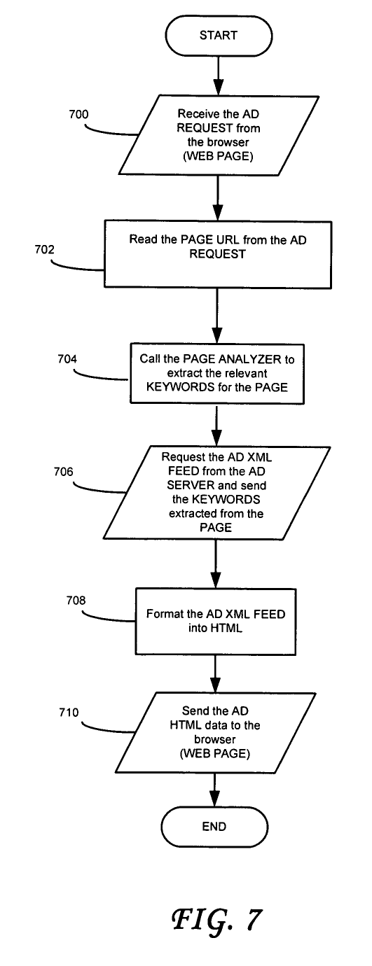

Further details relating to the methods performed by the analysis server 80 will now be considered with reference to FIGS. 6a and 6b, which include flowcharts describing the methodology of the embodiment including the page-keyword cache 82. It is contemplated that the page-keyword cache 82 is an information structure containing data associated with a particular URL as obtained from the location identifier 74, one or more keywords resulting from an analysis of the URL specified by the location identifier 74, and an expiration time. The expiration time is understood to be a numerical value that may specify an absolute time of expiration or a relative expiration interval. Additional data associations may be provided in the page-keyword cache 82, and need not be limited to those described herein.

According to step 600, an “ad request” is received from the web browser 28, that is, the web browser 28 parses the HTML output page 40 and the advertising identifier 42. As previously described, this parsing of the advertising identifier 42 is operative to query the analysis server 80. Accordingly, the term “ad request” as used herein is deemed to be equivalent to this query of the analysis server 80. Next, according to step 602, the page URL, which is specified by the location identifier 74, and a cache expiration time is retrieved from the ad request. The page URL is then searched among the page-keyword cache 82 per step 604.

Where the page URL is locatable within the page-keyword cache 82 and the retrieved cache expiration time does not indicate that the particular entry in the page-keyword cache 82 associated with the page URL has expired, the method continues with step 606. In step 606, the keywords associated with the particular page URL are retrieved from the page-keyword cache 82. Such keywords are also referred to as matching keywords. Thereafter, the method continues with step 612, where an advertising content request 84 is issued to the advertising database 45 specifying the transmission of the advertisement feed 44. The advertisement feed 44 contains advertisements relevant to the matching keywords in the form of an XML feed as previously described. Upon retrieving the advertisement feed 44, according to step 614, it is converted to appropriate HTML code so that it will be visible on the browser 28. Finally, according to step 616, such HTML code is rendered on the browser 28 along with the other content contained within the HTML output page 40.

On the other hand, where either the page URL is not locatable within the page-keyword cache 82 or the retrieved cache expiration time indicates the expiry of the particular entry in the page-keyword cache 82 associated with the page URL, the method continues with step 608. Here, the page analyzer 90 is called to extract relevant matching keywords from the HTML output page specified by the page URL. Upon completing the analysis, the matching keywords for that particular page URL is saved to the page-keyword cache 82 with an expiration time as per step 610. Thereafter, the method continues with step 612 as previously described.

With reference to FIG. 7, further details regarding the steps performed by the analysis server 80 without the page-keyword cache 82 will now be considered. According to step 700, as in step 600, an “ad request” is received from the web browser 28, that is, the web browser 28 parses the HTML output page 40 and the advertising identifier 42. Upon receiving the ad request, according to step 702, the page URL is ascertained based on the query 68 as previously described. Next, according to step 704, the page analyzer 90 is invoked on the HTML output page 40 as specified by the page URL. Matching keywords are extracted from the HTML output page 40 as a result of the step 704, and the advertising content request 84 is transmitted to the advertisement database 45 along with a list containing the matching keywords according to step 706. The advertisement database 45 generates the advertisement feed 44, which contains advertisements relevant to the matching keywords in the form of an XML feed as previously described. Upon retrieving the advertisement feed 44, according to step 708, it is converted to appropriate HTML code representative of the advertisements for proper rendering by the browser 28. Finally, according to step 710, such HTML code is rendered on the browser 28 along with the other content contained within the HTML output page 40.

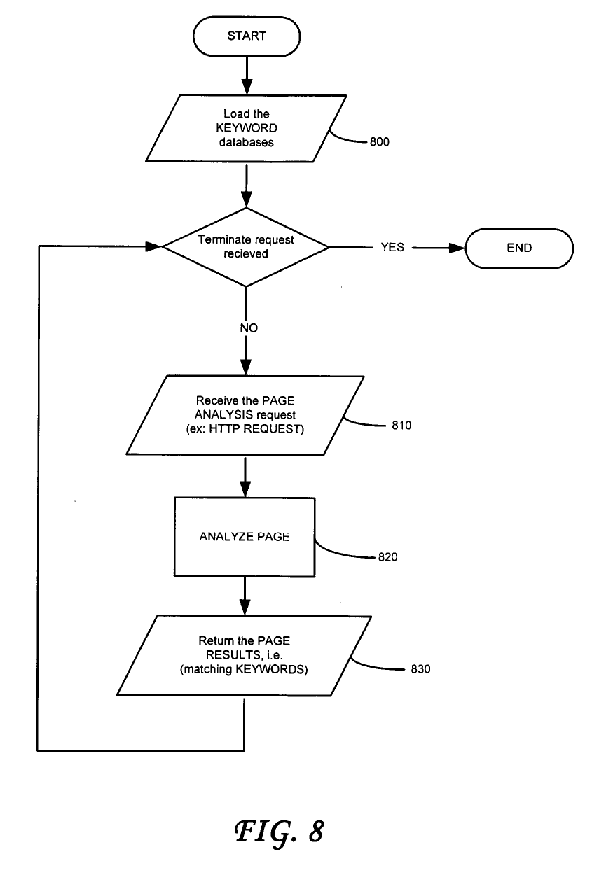

As will be appreciated, an important aspect of the present invention is the page analyzer 90. In this regard, with reference now to the flowchart of FIG. 8, a general overview of the steps performed by the page analyzer 90 will be considered. Beginning with step 800, a weighted keyboard database 86 is loaded into a memory. As mentioned above, multiple instances of the weighted keyword database 86 holding different values being loaded into such memory is contemplated. Upon receiving a page analysis request per step 810, that is, when the page analyzer 90 is called according to either one of steps 608 or 704 where the advertising identifier 42 is parsed on the browser 28 or the content provider server 30, the specified page is analyzed according to step 820, and the result of the analyzing step 820 is returned as a list of matching keywords.

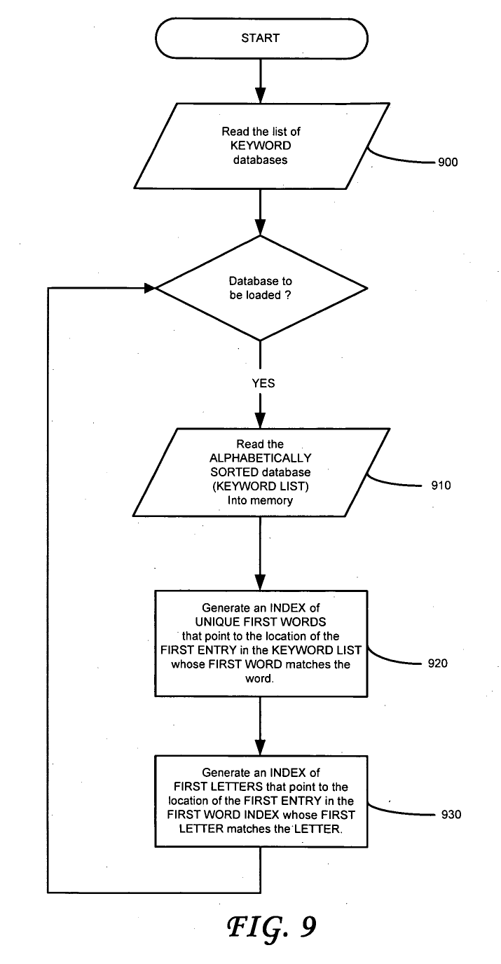

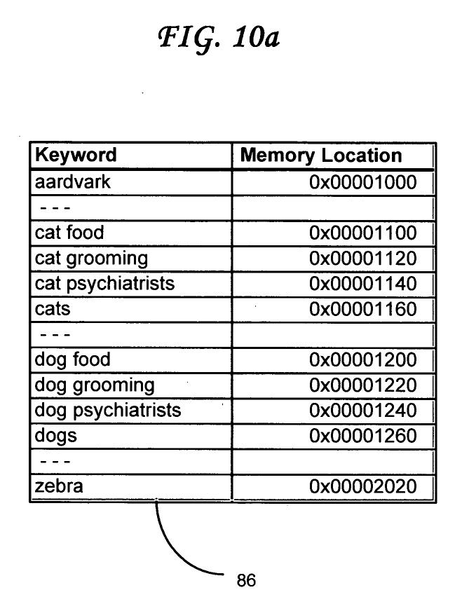

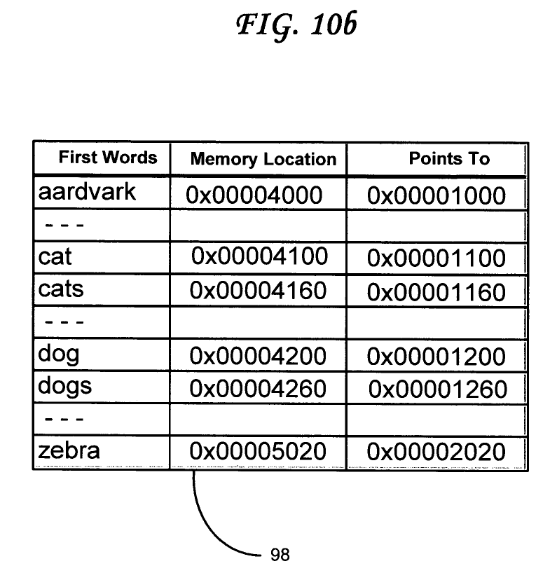

With regard to the weighted keyword database 86 and the loading thereof into the memory per step 900, further details of the same will be considered with reference now to FIG. 9. In order to improve data throughput during read operations, the keyword database 86 is loaded into memory in a particular way. As discussed above, there may be multiple instances of the weighted keyword database 86 depending on the locale, customers, and so forth. Thus, a list including all of such instances of the weighted keyboard database 86 is read, per step 900, and determined whether it should be loaded into memory or not. If it is, the particular weighted keyword database 86 is copied into a memory. It should be noted that the weighted keyword database 86 is alphabetically sorted according to one embodiment of the present invention. Thereafter, according to step 920, a word index of unique first words is generated, where each entry thereof includes a pointer to the first occurrence of that first word in the weighted keyword database 86. Then, per step 930, a letter index of first letters is generated. Each entry of the letter index includes a pointer to the first occurrence of that letter in the word index.

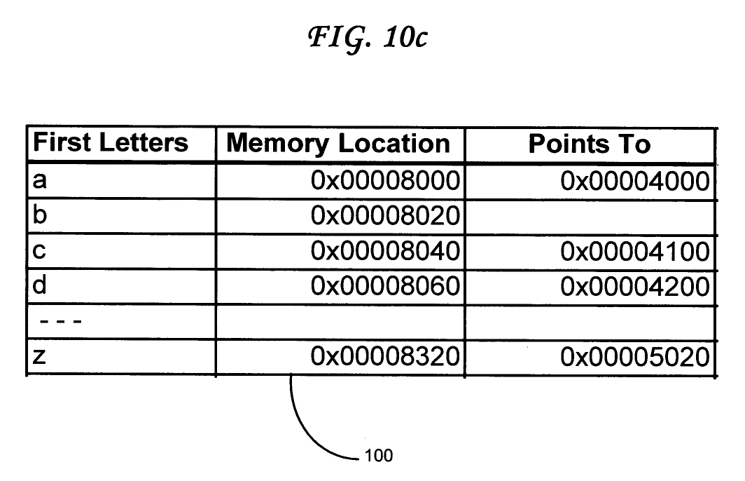

The above concept is best illustrated with reference to FIGS. 10a-10c, in which FIG. 10a shows the weighted keyword database 86 as loaded into the memory per step 910, FIG. 10b shows the word index as loaded into the memory per step 920, and FIG. 10c shows the letter index as loaded into the memory per step 930. As an example, the keyword “cat food” is listed in the weighted keyword database 86, and located at address 0x00001100. Next, the word “cat” is listed in the word index 98 at address 0x0004100, and includes a pointer to 0x00001100, the first occurrence of the word “cat” as a first word in the weighted keyword database 86. In the letter index 100, the first letter “c” is located at memory location 0x0008040, and includes a pointer to 0x0004100, the first occurrence of the letter “c” as a first letter in the word index 98. As will be appreciated, this storage technique increases the speed in which each word in a given HTML output page 40 can be pattern matched. The methods relating to accessing the weighted keyword database 86 in comparison operations will be discussed in further detail below.

On a broader level, the weighted keyword database 86 include entries chosen for the highest relevance to the page content. Entries are ranked with a weighted combination of the number of occurrences of the matching keyword on the page, the bidden price of the matching keyword by advertisers, the specificity, or length, of the keyword, and the frequency of use of the matching keyword in general internet searches. As understood, matching keywords can be mapped to other keywords where more relevance or higher value can be achieved. In some instances, specific words such as those identifying a locale, for example, are eliminated from the weighted keyword database 86 or reduced in weight when used on geographically specific websites. The keywords are constantly updated to remain relevant to continually changing social environments, so as to include celebrity names, current news topics, and the like.

The weighted keyword database 86 may be first generated from empirical data consisting of the number of times a month a word is used in a specific advertiser network and the bid price thereof. This massive list, which may include several million keywords, is filtered to be application-specific by selecting words exceeding a predetermined search frequency, eliminating adult or non-relevant words, removing words that are too long, and eliminating specific single or two word phrases that are too broad. After building the aforementioned list, the entries are analyzed within word groupings to adjust the weighting such that certain words within the set will override other words within the set. By way of example only and not of limitation, several consequences of this weighing will be illustrated with reference to the term “watches.” Table 1 lists a few variations of the term “watches:”

TABLE 1

| Keyword | Frequency | Price |
|---|---|---|
| Watch(es) | 358,599 | $1.03 |
| Men's Watch(es) | 172,722 | $1.50 |
| Sports Watch(es) | 2,704 | $1.10 |
| Women's Watch(es) | 5,554 | $0.64 |

In the above example of Table 1, the price for the word “watch” is reduced in weight so that it has the lowest value amongst the other keywords containing the term “watch(es).” This permits more relevant two or more word keywords to take precedence in a page analysis. For example, if the user views a page having the terms “watch(es)” and “women's watch(es),” the latter will prevail since it is more specific. If there are many combinations of keywords containing the term “watch(es)” on the page, the keyword “watch(es)” will prevail as it will occur more frequently that other keywords. In the event of identical counts and weighting, the keyword search frequency is determinative. Typically, single word keywords are removed from the weighted keyword database 86 as being too generic. Content providers may also be able to exercise a degree of control over the display of advertisements by enclosing specific phrases within predetermined tags. By way of example only and not of limitation, such predetermined tags are “<newselement>” and “</newselement>”. Upon being analyzed by the page analyzer 90, the words enclosed within such tags are assigned extra weight. Along these lines, it is contemplated that these tags may be modified by additional parameters that modify the weight assigned by different amounts. In other words, there may be degrees of weight assigned to particular keywords, and need not be limited to the binary statuses of being emphasized or not emphasized.

As understood, the weighted keyword database 86 can be tailored for analyzing locally relevant websites. In this regard, low frequency words may be reinstated, and words which may occur too frequently are removed. For example, for a Boston area newspaper, the keyword “Boston Pops” may appear so infrequently as to have been removed from the weighted keyword database 86, but for local use, this term may be reinstated. Further, continuing with the Boston area newspaper example, the keyword “Boston” may appear so frequently as to warrant removal.

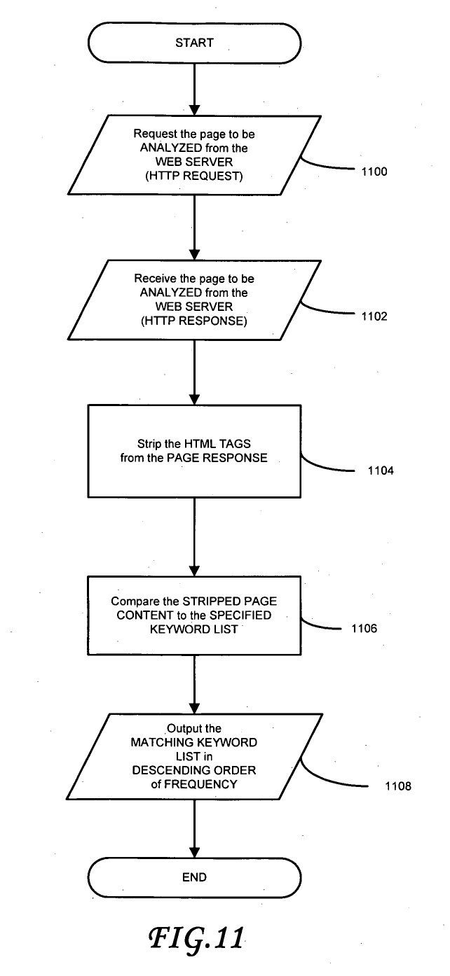

Having considered the details of the weighted keyword database 86 and the way it is loaded into memory per step 800, further details pertaining to the other generalized step 820 of analyzing the page will be considered. With reference to FIG. 11, the method includes a step 1100 of requesting the page to be analyzed from the content provider server 30. Further, the method provides for a step 1102 of receiving the HTML output page 40 that is to be analyzed from the content provider server 30. As described above, these steps are initiated by the browser 28 when the advertising identifier 42 is parsed thereby. This transmits the query 68 to the analysis server 80, and the page analyzer 90 retrieves the page per the step 1100 and the step 1102. After step 1102, the analysis server 80 is holding in memory a copy of the HTML output page 40, referred to hereinafter as the page response.

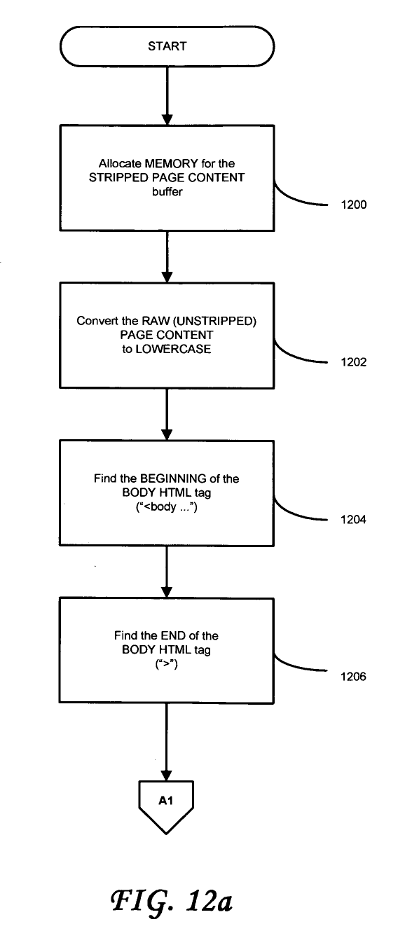

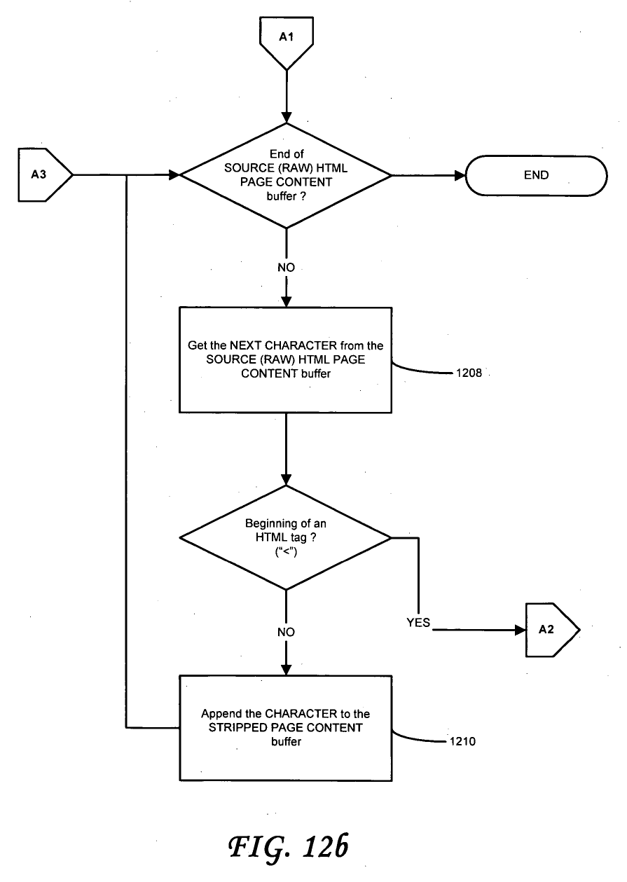

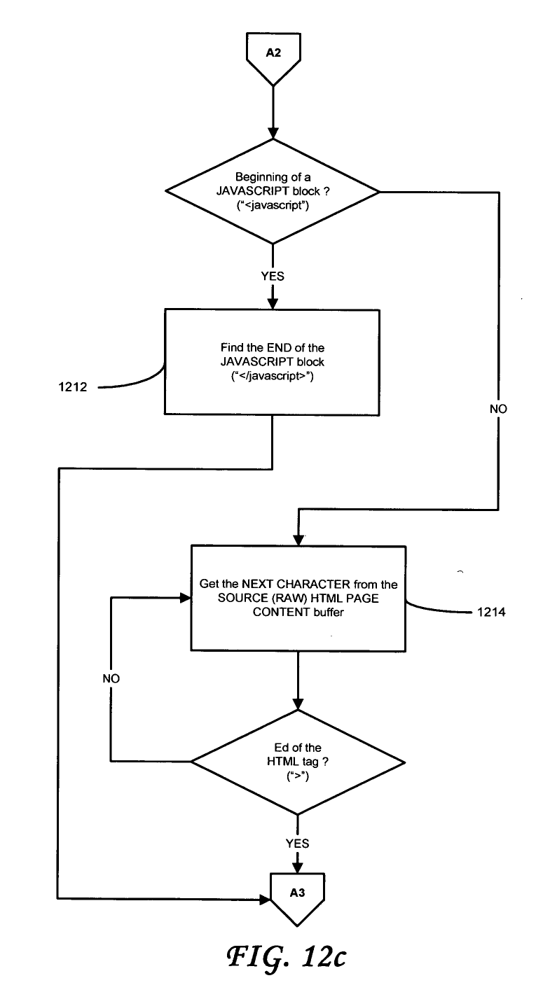

The page response is stripped of HTML tags according to step 1104 and yielding a stripped page content. This stripped page content is compared to keywords in the weighted keyword database 86 in step 1106, and the results of the comparison step are output as the matching keywords to the advertisement database 45 in step 1108. The stripping and comparing steps will be explained in further detail below, with reference to FIGS. 12a-c, 13a-c, and 14a-e.

With particular reference to FIGS. 12a-c, the page response from the content provider server 30 is stripped of HTML tags contained within. The process begins with step 1200, in which memory is allocated for a buffer to store the stripped page content. Then, all of the text of the page result is converted to lower case in step 1202, and the beginning and end of the page result as delineated by the “<BODY . . . ” and “>” HTML tags are established in steps 1204 and 1206, respectively. One of ordinary skill in the art will be able to readily ascertain the programmatic techniques involved with the implementation of these steps. According to step 1208, each character of the page response is retrieved, and determined whether or not it is the beginning of an HTML tag, i.e., whether or not it is a “<” character. Characters determined not to be the beginning of an HTML tag are appended to the buffer per step 1210, while characters determined to be the beginning of an HTML tag are discarded per steps 1212 and 1214. After traversing through the text of the page result, stored in the buffer is the stripped page content.

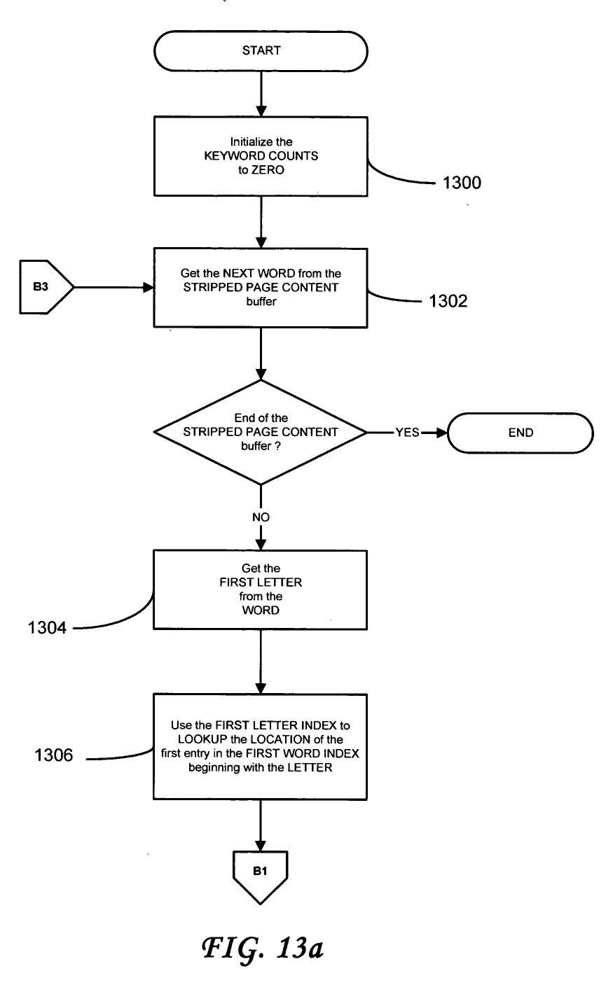

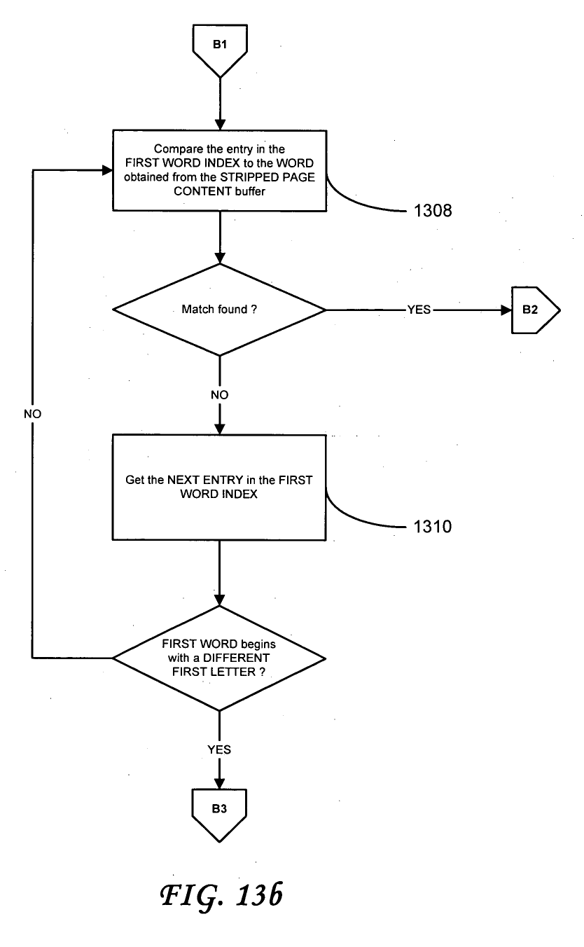

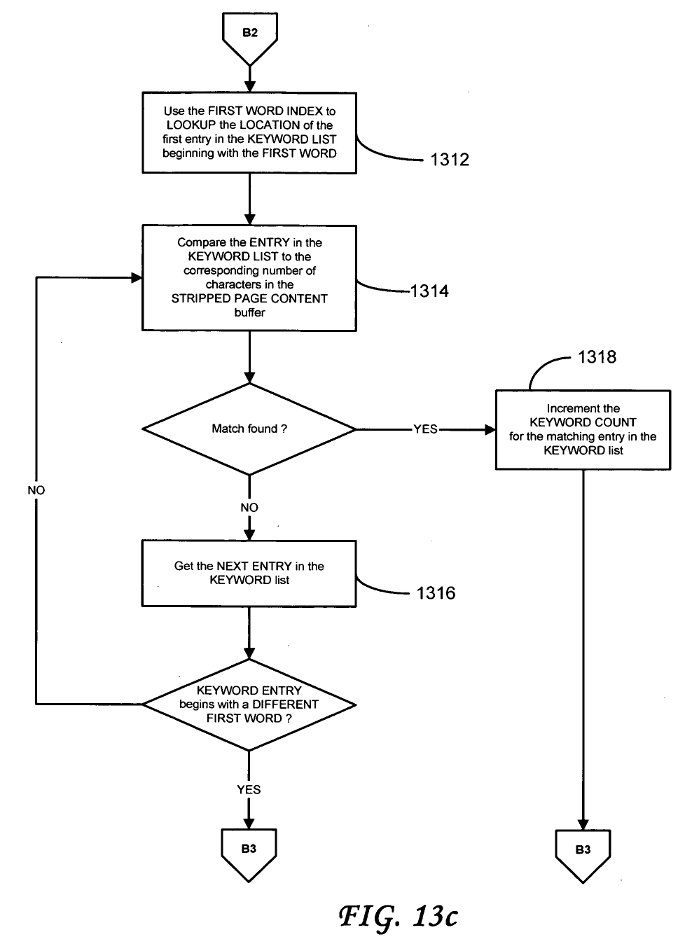

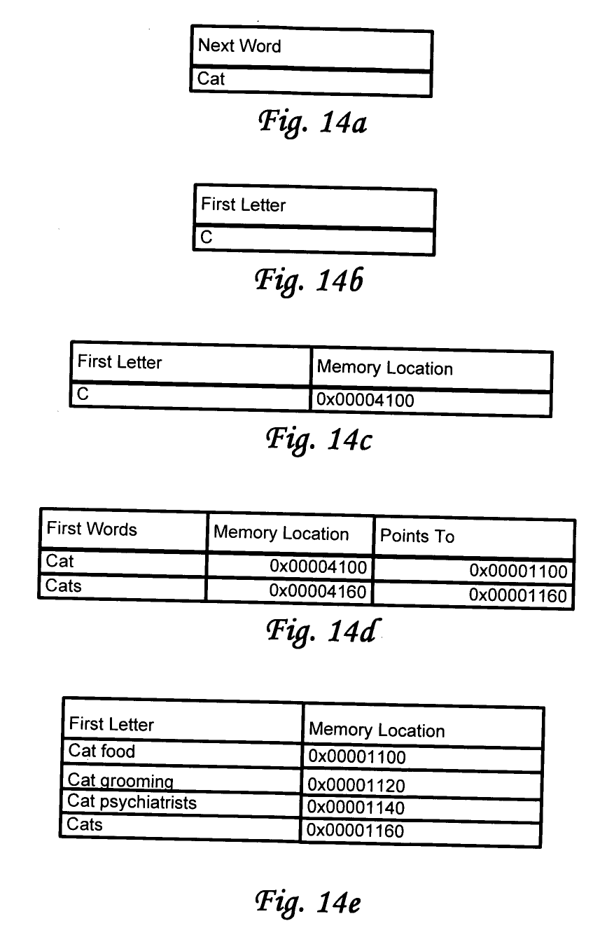

Referring to FIGS. 13a-c, the process of comparing the text of the stripped page content to the weighted keyword database 86 for extracting a list of matching keywords will be discussed. According to step 1300, a count variable is initialized to zero. It is understood that a new count variable is initialized for each matching keyword found in the stripped page content. In step 1302, the subsequent word in the buffer with the stripped page content is retrieved. By way of example, as illustrated in FIG. 14a, the word retrieved from the buffer is “cat.” Next, in step 1304, the first letter of the word retrieved from the buffer is determined, which, as illustrated in FIG. 14b, is “c”. Per step 1306, the letter index 100 is consulted to determine the location of the first entry in the word index beginning with the first letter, “c.” As illustrated in FIGS. 10c and 14c, the letter “c” has a pointer to location 0x00004100 associated therewith. In step 1308, the entry in the word index 98 pointed to from the letter index 100 is compared to the word retrieved from the buffer. Since memory location 0x00004100 as shown in FIGS. 10b and 14d is associated with the word “cat,” that first word is a match with the same word retrieved from the buffer. If there is no match, the next entry in the word index 100 is retrieved according to step 1310. If the first letter is different, then the process repeats from step 1302, and otherwise, next entry in the word index 100 is compared with the word retrieved from the buffer for equivalence. Having found a match between the entry on the word index 100 and the word retrieved from the buffer, the next step 1312 is to use the word index 100 to lookup the location of the first entry in the matching keyword list beginning with the first word of the keyword. In accordance with step 1314, the entry in the weighted keyword database 86 is compared with the subsequent word found after the matching first word to determine whether the keywords as a whole are matching. If not, step 1314 is repeated after retrieving the next keyword in the weighted keyword database 86 as per step 1316. In the particular example illustrated in FIG. 14e, there is no keyword which is just “cat,” so there will not be a match unless the subsequent word in the buffer is “food,” “grooming” or “psychiatrists.” If matching, according to step 1318, the count variable for that particular keyword is incremented. Whether matching or not, the method continues with step 1302, where the next word from the buffer is retrieved for analysis as described above. With regard to the generation advertising content request 84 and the determination of the contents thereof, one of ordinary skill in the art will be able to readily ascertain the various ways in which the matching keywords are communicated to the advertisement database 45.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description taken with the drawings making apparent to those skilled in the art how the several forms of the present invention may be embodied in practice.

What is claimed is:

1. A method for providing advertising content from an advertising database, the method comprising the steps of:
scanning content data of a target server for a matching keyword from a weighted keyword database;
generating a subset of the content data, the subset being the matching keyword;
assigning a weight to the matching keyword based upon a comparison to the weighted keyword database; and
generating an advertising content request in accordance with the assigned weight, the advertising content request being operative to initiate the transmission of advertising content from the advertising database.

2. The method of claim 1 comprising the additional step of storing the subset of the content data in a cache.

3. The method of claim 2 wherein the assigned weight is stored in the cache.

4. The method of claim 2 wherein the subset of the content data in the cache and the assigned weight is periodically refreshed.

5. The method of claim 1 comprising the additional step of transmitting advertising content to the target server.

6. The method of claim 5 comprising the additional step of incorporating advertising content onto a webpage located on the target server.

7. The method of claim 1 comprising the additional step of transmitting advertising content to a client browser.

8. The method of claim 7 comprising the additional step of incorporating advertising content into a webpage being rendered on the client browser.

9. The method of claim 1 comprising the additional step of preselecting an area in a webpage for receiving the transmitted advertising content.

10. The method of claim 1 wherein the advertising content is located on a first server.

11. The method of claim 1 wherein the scanning of content data on a target server is initiated from a second server.

12. An article of manufacture comprising:
a computer useable medium having computer-readable program code for:
scanning content data of a target server for a matching keyword from a weighted keyword database;
generating a subset of the content data, the subset being the matching keyword;
assigning a weight to the matching keyword based upon a comparison to the weighted keyword database; and
generating an advertising content request in accordance with the assigned weight, the advertising content request being operative to retrieve advertising content from an advertising database.

13. A system for providing advertising content comprising:
at least one memory for storing a weighted keyword database;
a processor for scanning content data off a target server for a matching keyword from the weighted keyword database; for generating a subset of the content data, the subset being the matching keyword; for storing the subset on the at least one memory; for assigning a weight to the matching keyword based on a comparison to the weighted keyword database; for generating an advertising content request in accordance with the assigned weight; transmitting the advertising content request; and retrieving the advertising content from an advertising database.

14. The system of claim 13 further comprising a system server for storing the code necessary to execute the scanning of the target server.

15. The system of claim 13 further comprising an advertising content server for storing the advertising content.
